(19) United States
(12) Patent Application Publication
(10) Pub. No.: US 2026/0000192 A1
(43) Pub. Date: Jan. 1, 2026

(54) Modular Activity Surfaces and Systems and Devices for Configuring and Connecting Modular Activity Surfaces Modules

(71) Applicant: Autonomous Inc., Riverside, CA (US)

(72) Inventors: Long Thanh Ha, Ho Chi Minh City (VN); Nam Phuong Mai, Dak Lak (VN)

(21) Appl. No.: 18/761,157

(22) Filed: Jul. 1, 2024

(51) Int. Cl. A47B 21/06; A47B 13/16; H01R 13/631

(52) U.S. Cl. CPC A47B 21/06; A47B 13/16; H01R 13/6315; A47B 2021/066

(57) ABSTRACT

A novel modular activity surface with a base that may have a plurality of base connectors that are spaced apart from one another, and a plurality of modules. Each module has a top surface and a bottom surface, and a first has a first module connector located on the bottom surface of the first module that is configured to connect to a first base connector from the plurality of base connectors of the base when the first module is removably attached to the base. A device connector may have a module connector with pins that are electrically connected to a first circuit and a connector configured to supply electrical power, and a base connector having a plurality of circular contacts configured to mate with the plurality of pins when the module connector and base connector are mated. The circular contacts and the port are electrically coupled to a second circuit.

### BACKGROUND

A working surface, like a desk or table, is generally a piece of furniture designed for individuals to perform tasks, organize materials, and facilitate productivity in a workspace. It typically consists of a flat surface supported by legs or other structures, providing a stable platform for various activities. Desks and tables come in a range of sizes, shapes, and materials to suit different needs and preferences. They often feature additional elements such as drawers, shelves, or compartments for storage, allowing users to keep essential items close at hand. Desks and tables play a central role in home and office environments, home offices, schools, and other settings where focused work or study is conducted. They serve as functional workstations where individuals can comfortably and efficiently carry out their tasks.

The introduction of personal computers and electronic devices influenced desk and table design. And while desks have evolved to accommodate technology, with features like cable management and keyboard trays becoming common, they can quickly become cluttered and difficult to manage given the number of cables required to power electrical devices, such as peripherals and accessories people increasingly rely on. Additionally, items such as monitor stands, document and utensil holders, task lighting, charging stations, and so forth, can make organizing a working surface bothersome.

Further, electrically connecting electronic devices that are placed on a working surface is cumbersome. Present solutions require messy cable routing solutions like zip ties, channeling, and wire holders and fasteners that can take hours to set up and, crawling under the table or desk to set up, and once set up, are inflexible and difficult to reconfigure. And while some electrical fasteners existing that allow for detachable electrical coupling of male and female fasteners, such as the pogo pin connector solutions described in U.S. Pat. Nos. 8,062,078B2, 8,337,256B1, US20150280343A1, and U.S. Pat. No. 11,437,768B2, they still require customized configuration to the working surface and dedicated wiring in order to provide a minimal, clean experience when connecting electronic devices and peripherals.

### SUMMARY

In some aspects, the techniques described herein relate to a modular activity surface including: a base including a base surface having a plurality of base connectors that are spaced apart from one another; a plurality of modules, each module of the plurality of modules having a top surface and a bottom surface, where a first module of the plurality of modules has a first module connector located on the bottom surface of the first module that is configured to connect to a first base connector from the plurality of base connectors of the base when the first module is removably attached to the base.

In some aspects, the techniques described herein relate to a modular activity surface, where coupling the first module connector of the first module to the first base connector of the base removably fastens the first module to the base.

In some aspects, the techniques described herein relate to a modular activity surface, where the top surface of the first modules includes one of a portion of a table surface; an electrical socket for an accessory, a utensil organizer, a storage pocket, and a storage compartment.

In some aspects, the techniques described herein relate to a modular activity surface, further including: a power unit electrically connected to the plurality of base connectors and configured to electrify the plurality of base connectors.

In some aspects, the techniques described herein relate to a modular activity surface, where the first module connector includes an electrical component, and coupling the first module connector of the first module to the first base connector of the base removably fastens the first module to the base and electrically connects the electrical component to first base connector via the first module connector.

In some aspects, the techniques described herein relate to a modular activity surface, where: the plurality of modules includes a second module connector spaced a certain distance apart from the first module connector; plurality of base connectors includes a second base connector spaced the certain distance apart from the first base connector; and the first module is removably fastened to the base includes by coupling the first module connector of the first module to the first base connector of the base and coupling the second module connector for the first module to the second base connector of the base.

In some aspects, the techniques described herein relate to a modular activity surface, where the first module is removably fastenable to the base via one of two base connectors, three base connectors, and four base connectors.

In some aspects, the techniques described herein relate to a modular activity surface, where the plurality of modules includes a second module having a second module connector located on the bottom surface of the second module that is configured to connect to a second base connector from the plurality of base connectors of the base when the second module is removably attached to the base.

In some aspects, the techniques described herein relate to a modular activity surface, where the first module and the second module collectively form at least a portion of the surface of the modular activity surface when removably attached to the base.

In some aspects, the techniques described herein relate to a device connector, including: a module connector having a plurality of pins electrically connected to a first circuit and a connector configured to supply electrical power when the module connector is electrically coupled to the base connector, where the base connector has a plurality of circular contacts configured to mate with the plurality of pins when the module connect and base connector are mated, the base connector has a port for receiving electrical power, and the plurality of circular contacts and the port are electrically coupled to a second circuit.

In some aspects, the techniques described herein relate to a device connector where the pins include pogo pins.

In some aspects, the techniques described herein relate to a device connector where the circular contacts are concentric.

In some aspects, the techniques described herein relate to a device connector, further including: a housing of the module connector and a housing of the base connector each have a preconfigured shape such that when the module connector and the base connector are mated, the module connector can rotate relative to the base connector while the plurality of pins of the module connector maintain contact with the circular contacts of the base connector.

In some aspects, the techniques described herein relate to a device connector, further including: a housing of the module connector and a housing of the base connector each has a rectangular or square outer shape such that when the module connector and the base connector are mated, where the module connector can rotate around a vertical axis relative to the base connector in 90 degree increments while the plurality of pins of the module connector maintain contact with the circular contacts of the base connector.

In some aspects, the techniques described herein relate to a device connector, further including: a housing of the module connector and a housing of the base connector each has a triangular outer shape such that when the module connector and the base connector are mated, where the module connector can rotate around a vertical axis relative to the base connector in 120 degree increments while the plurality of pins of the module connector maintain contact with the circular contacts of the base connector.

In some aspects, the techniques described herein relate to a network of device connectors, including: a plurality of connector devices each having a plurality of ports, each connector device having a plurality of ports allowing up and downstream electrical connections to a power supply, a first connector device of the plurality of the connector devices being electrically coupled to a power supply via first port and being electrically coupled to a downstream port of a second connector device, each of the connector devices including a module connector that is electrically detachably coupled to a base connector.

In some aspects, the techniques described herein relate to a network of device connectors, where: the network includes at least one or more of a circular network of the connector devices from the plurality of connector devices, a triangular network of the connector devices from the plurality of connector devices, a square network of connector devices from the plurality of connector devices, a rectangular network of connector devices from the plurality of connector devices, a diamond network of the connector devices from the plurality of connector devices, a pentagonal network of the connector devices from the plurality of connector devices, a hexagonal network of the connector devices from the plurality of connector devices, and a star-shaped network of the connector devices from the plurality of connector devices.

In some aspects, the techniques described herein relate to a network of device connectors, where the square network, diamond network, and the rectangular network include four or more device connectors; the pentagonal network includes five or more device connectors; the hexagonal network includes six or more device connectors; and the star-shaped network includes six or more device connectors.

In some aspects, the techniques described herein relate to a network of device connectors, where one or more of the square network, the diamond network, the rectangular network, the circular network, the triangular network, the pentagonal network, the hexagonal network, and the star-shaped network include a central connector device.

In some aspects, the techniques described herein relate to a network of device connectors, where the network provides for power transmission and data transmission between the device connectors of the plurality of device connectors.

These systems, devices, methods, apparatus, and computer program products are particularly advantageous in a number of respects, as discussed in detail in this disclosure. However, this list of features and advantages is not all-inclusive and many additional features and advantages are within the scope of the present disclosure. Moreover, it should be noted that the language used in the present disclosure has been principally selected for readability and instructional purposes, and not to limit the scope of the subject matter disclosed herein.

### BRIEF DESCRIPTION OF THE DRAWINGS

This disclosure is illustrated by way of example, and not by way of limitation in the figures of the accompanying drawings in which like reference numerals are used to refer to similar elements.

FIG. 1A illustrates a diagram of an example embodiment of a modular activity surface.

FIGS. 1B and 1C illustrate the relative dimensions and configuration options for different example modules.

FIGS. 2A, 2B, 2C, and 2D show different layouts that can be produced by changing out and/or rearranging various example modules.

FIG. 3 illustrates the example modular activity surface with the modules removed and the power unit affixed.

FIG. 4 illustrates an electrical schematic of an example modular activity surface.

FIG. 5A illustrates a perspective view of an example connector device.

FIGS. 5B and 5C illustrate cross-sectional views of the example connector device showing the internal structure and connection pins.

FIG. 6A illustrates top and bottom perspective views of a connector device having connection pins in a circular configuration.

FIG. 6B illustrates top and bottom perspective views of a connector device having connection pins in a circular configuration and housing having a diamond-shaped configuration.

FIG. 6C illustrates top and bottom perspective views of a connector device having connection pins in a circular configuration and housing having a square-shaped configuration with rounded corners.

FIG. 6D illustrates perspective views of the example devices of FIGS. 6A, 6B, and 6C in a coupled state.

FIG. 7 illustrates top and bottom perspective views of a connector device having connection pins in a circular configuration and housing having a rectangular-shaped configuration.

FIG. 8 illustrates top and bottom perspective views of a connector device having connection pins in a circular configuration and housing having a hexagonal-shaped configuration.

FIG. 9 illustrates top and bottom perspective views of a connector device having connection pins in a circular configuration and housing having an octagonal-shaped configuration.

FIG. 10 illustrates an example serial network of connector devices.

FIG. 11 illustrates an example triangular network of connector devices.

FIG. 12 illustrates an example rectangular network of connector devices.

FIG. 13 illustrates an example diamond-shaped network of connector devices.

FIG. 14 illustrates an example pentagonal network of connector devices.

FIG. 15 illustrates an example hexagonal network of connector devices.

FIG. 16 illustrates an example circular network of connector devices.

FIG. 17A illustrates connector devices of example passive and electronic modules.

FIG. 17B illustrates a diagram of attaching an example module to a base of a modular activity surface.

FIG. 17C illustrates a diagram of an example module attached to a base of a modular activity surface.

FIG. 18 illustrates dimensions of an example base of a modular activity surface.

FIG. 19 illustrates dimensions of example modules.

FIG. 20 illustrates an example desk setup.

FIGS. 21 and 22 illustrate two example desk setups.

### DETAILED DESCRIPTION

With the rise of technology and the proliferation of electronics that people use daily, keeping one's surfaces, whether those surfaces are counters, side tables, desks, tables, unelevated or elevated activity surfaces, or any other activity area in which organization is desired, can be challenging. The technology described herein solves these are other problems by providing novel modular activity surface and connector devices solutions, such as modular activity surfaces, systems, and devices for configuring and connecting modular activity surfaces modules. As described further herein, these solutions bear a number of advantages including ease of use and setup, flexible configuration without having to rewire, remodel or otherwise rehabilitate the environment; self-aligning device connectors that ease the attachment, reconfiguration, and changing out of modules or other electrical components; the flexible configuration of one or more networks of electrified devices via easy to use and arrange device connectors.

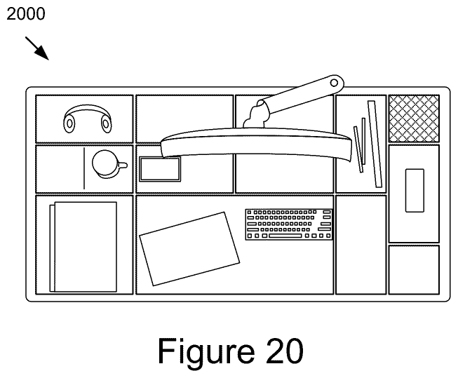

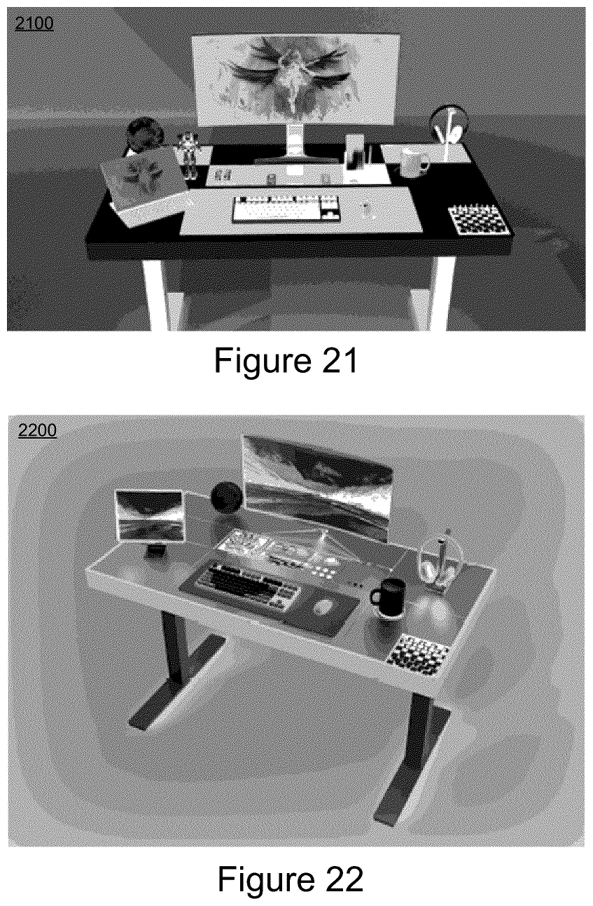

In some embodiments, the novel modular activity surfaces, such as a bearing surface like a desk or table configured to support any number of items, comprise user configurable modules that can be interchanged to provide desired functionality via innovative connector devices. Example modules may include personal computer, table, laptop or other electric device modules designed to support and or power such devices; monitor stand modules configured to support and/or power monitors or televisions, keyboard; mouse and/or other input device modules configured to store, support, and/or power such devices; modules comprising desk organizers for pens, pencils, and other office supplies; modules for providing, supporting, and/or electrifying desk lamp or task lighting for adequate illumination; modules for storing files, papers, and other conventional workplace items; and/or personalized modules that accessorize the surface such as photos, plants, or decorative objects; and so forth. FIGS. 20, 21, and 22 depict three such example modular activity surfaces 2000, 2100, and 2200 providing a user-optimized desktop environment.

In a further embodiment, the activity surfaces could comprise a workshop surface having modules configured to store, support, and/or electrify power tools, fasteners, building materials, replacement parts, electronic devices (e.g., computers, testing equipment, production equipment, etc.). Other example embodiments may comprise surfaces in residential or commercial kitchens, doctor or dentist offices, craft rooms, living rooms or bedrooms, etc., in which modules are configured for the specific task and/or requirements of the activities being conducted in those environments. As such, it should be understood that any suitable activity in which organization and ease of use is desired could likely be accommodated via the technology described herein.

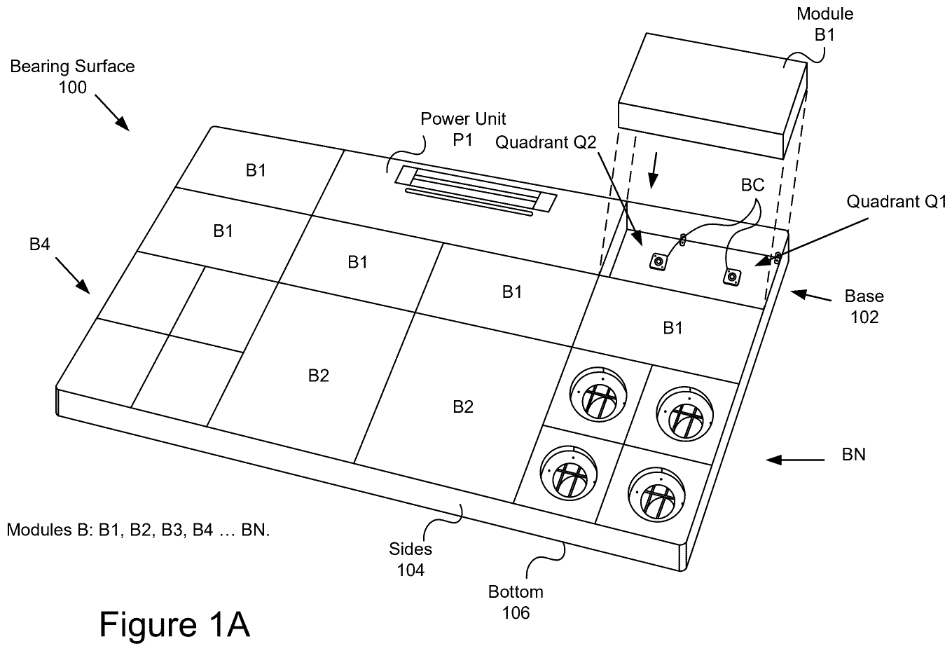

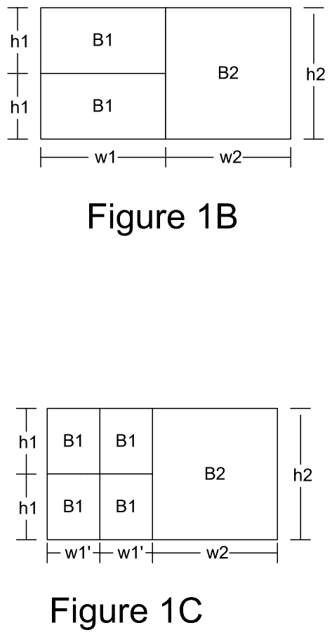

FIG. 1A illustrates a diagram of an example embodiment of a modular activity surface 100. As shown, the modular bearing service 100 the comprise a base 102 having a bottom 106 and sides 104 that form a recess in which modules B can be inserted and removably coupled. In the depicted embodiment, the sides 104 extend continuously around a periphery of the modular activity surface 100 and are attached on a lower end to the base 102, thus forming a wall around the periphery of the modular activity surface 100.

As further shown in FIG. 1A, the bearing surface 100 may include a plurality of different types of modules B1, B2, B3, B4, and BN (collectively referred to as B) to provide a variation of functionalities, configurations and layouts to the bearing surface. As shown, the modules B may have preconfigured dimensions so as to provide a user with predictable layout options. For example, As shown in FIG. 1B, modules B1 have the same height h1, which, when added, equal the height of module B2, which has a height of h2, whereas the widths w1 of modules B1 are the same as the width w2 of module B2. As a result, when two modules B1 are stacked height wise, their combined dimensionality and surface area is the same as module B2.

Similarly, as shown in FIG. 1C, four modules B1, when arranged adjacently as depicted, collectively have the same surface area and directionality as module B2 because the height h2 of module B2 is twice that of the height h1 of each module B1, and the width w2 of module B2 is twice that of the width w1′ of each module B1.

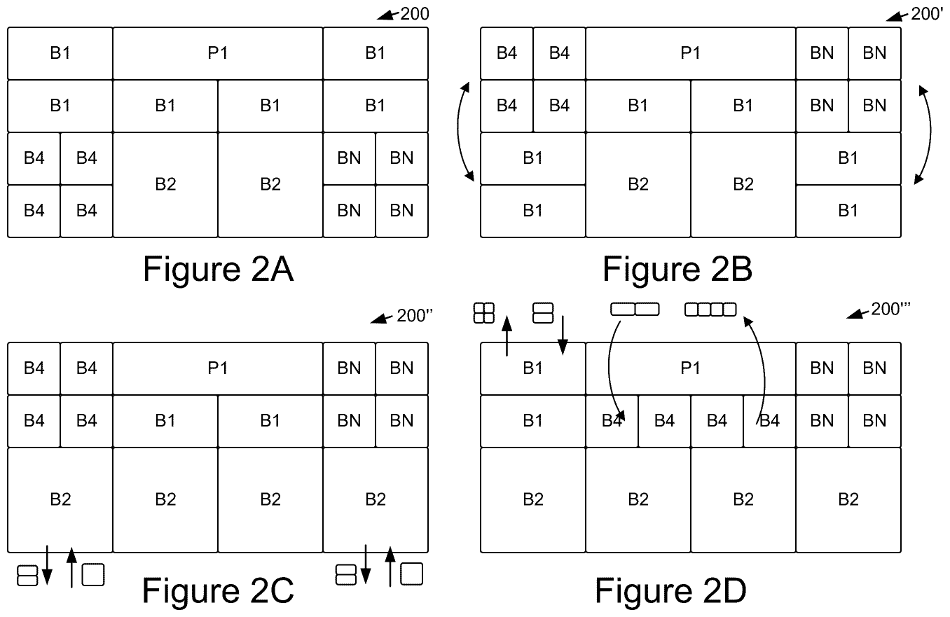

To further illustrate the configurability of the modular activity surface 100, FIGS. 2A, 2B, 2C, and 2D show how the layout 200 can be modified by swapping various modules. For example, in FIG. 2A, the modular activity surface 100 has the same layout 200 as that shown in FIG. 1A. In the layout 200′ shown in FIG. 2B, the four B4 and BN modules have each been swapped with two B1 modules on the left and right sides of the bearing surface 100, respectively, as illustrated by the arrows. In the layout 200″ shown in FIG. 2C, layout 200′ of FIG. 2B has been modified by swapping out two B1 modules with one B2 module on both the lower left and right sides. As a further progression, in the layout 200″ shown in FIG. 2D, the layout 200″ of FIG. 2C has been modified by swapping out the central two B1 modules with four B4 modules and swapping out the four left B4 modules with two B1 modules. It should be understood that these layouts are provided by way of example and that any suitable layout or configuration could be achieved by arranging the modules in the desired fashion. Additionally, while it should be understood that modules B1, B2, B3, and B4 are provided by way of example and that a given module could have any suitable shape, configuration, and/or functionality based on the desired outcome, as further discussed elsewhere herein.

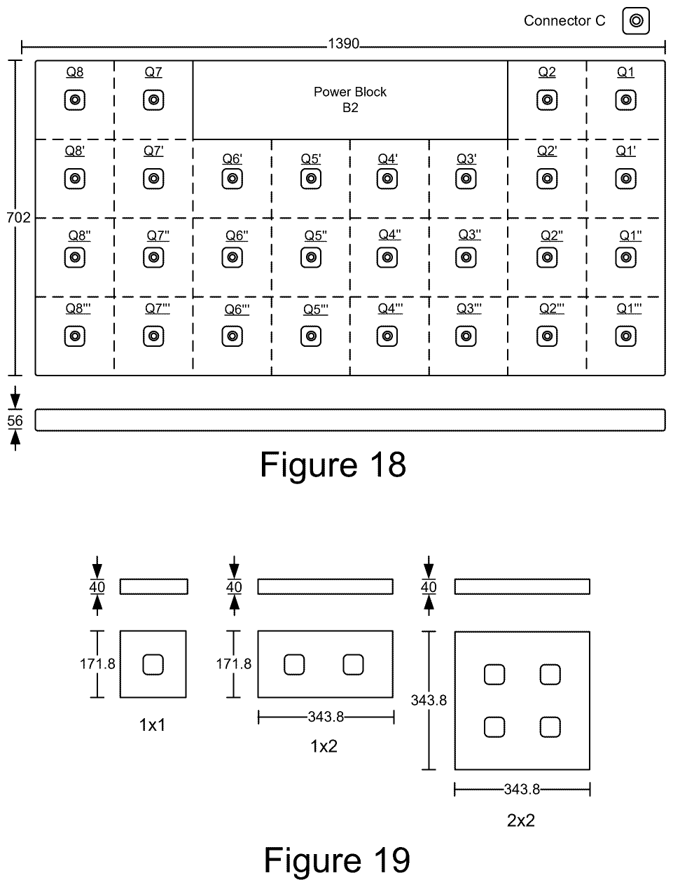

FIGS. 18 and 19 illustration example dimensions of a given modular activity surface 100 and corresponding modules B. Specifically, FIG. 18 illustrates dimensions of an example base 102 of a modular activity surface in which the base 102 has a 1390 mm length, a 702 mm width, and a 56 mm height. FIG. 19 illustrates dimensions of example modules in which a small module is 171.8 mm in length and width, and 40 mm in height; the medium module is 343.8 mm in length, 171.8 mm in width, and 40 mm in height; and the large module is 343.8 mm in length and width, and 40 mm in height.

However, it should be understood that the dimensions described herein are provided by way of example and the modules and base can have any suitable dimensions based on the application being served and are not constrained to square or rectangular use cases but may have any variety of shapes and sizes configured to provide a desired aesthetic, structure, and/or functionalities.

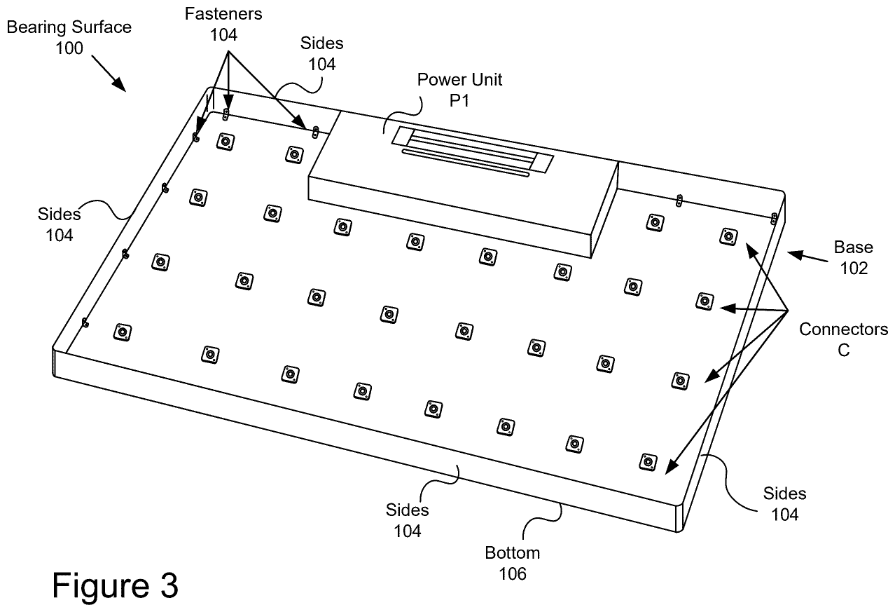

FIG. 3 illustrates the example modular activity surface 100 with the modules B removed and the power unit P1 affixed. As in FIG. 1A, the base 102 of the modular activity surface 100 includes a bottom 106 and sides 104 attached along a periphery of the bottom 106 via fasteners 108n that are located around that periphery, such as brackets and screws. It should be understood that the fasteners may comprise an adhesive that adheres the sides 104 to the bottom 106, or any other suitable fastener type, such as hook and look, rivets, welds, and so forth. In further embodiments, the bottom 106 and sides 106 may be formed of a single piece or multiple pieces that are joined together. Other variations are also possible and contemplated.

The bottom 106 of the base 102 further includes a plurality of base connectors BC. In the depicted embodiment, the base connectors BC are arranged in a lattice configuration in which the base connectors BC are spaced substantially equally apart to allow for compatibly sized modules B, such as those described with respect to FIGS. 1A-2D, to be installed and rearranged based on the needs of the user.

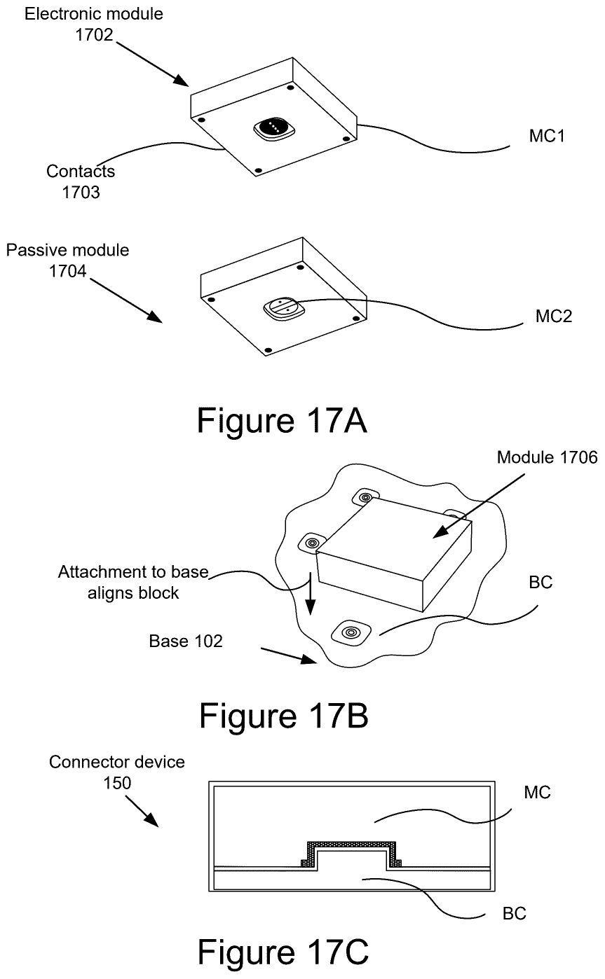

For instance, as shown in FIG. 17A, illustrates module connectors of example passive and electronic modules. Specifically, the electronic module 1702 includes a module connector MC1 having contacts 1703 configured to electrically connect the electronic module to the base 102 via a corresponding base connector BC. The passive module 1704 is non-electrical and includes a module connector MC2 that lacks contacts 1703 or may include dummy contacts that are not electrically coupled to any downstream components.

Further, FIG. 17B illustrates a diagram of attaching example module 1706 to the base 102 via base connector BC and module connect MC, which together form the connector device 1708. As shown, the respective shapes of the base connector BC and module connector MC guide the module into position in the respective quadrant(s) of the base 102 for easy convenient coupling. Additional features, structure, and functionality of the module-base connector devices are discussed in further detail elsewhere herein.

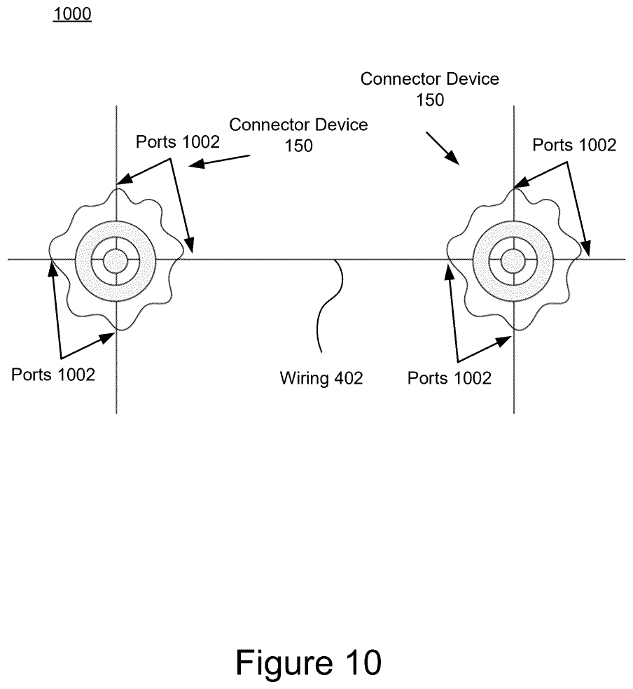

It should be understood that the base connectors BC may be arranged in a variety of different configurations suitable to the purpose in which they are being used. It should be further understood that the networking of connector device advantageously provides flexibility in wiring and connecting a plurality of electrified modules for a variety of applications beyond activity surfaces and is applicable to any application where electrical modules are laid out in a desired format or arrangement. For instance, dedicated wiring for each module is not necessary and instead can be daisy chained via the network of connector devices. FIGS. 10-16 illustrate various examples of different connector device network options, any of which may be connected together to form larger networks, such as the lattice network depicted in FIG. 1 or networks including serial, triangular, rectangular, circular, and/or any other suitable network configurations, such as but not limited to those described in FIGS. 10-16.

Specifically, FIG. 10 illustrates an example serial network 1000 of connector devices in which at least two connector devices 150 are electrically connected together via wiring 402. The wiring may detachably connect via ports 1002 of each connector device 150, allowing the connector devices to be connected in any desired fashion (e.g., series, parallel, a combination of the foregoing, etc.).

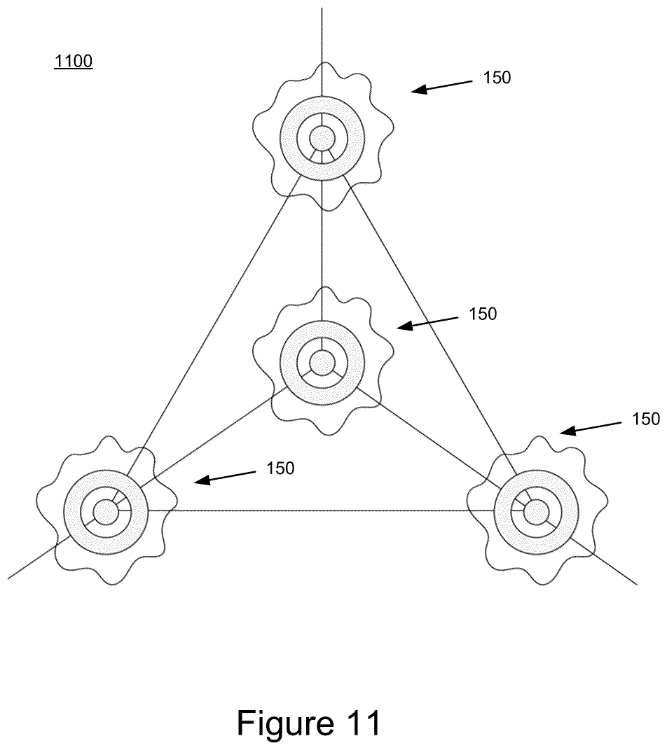

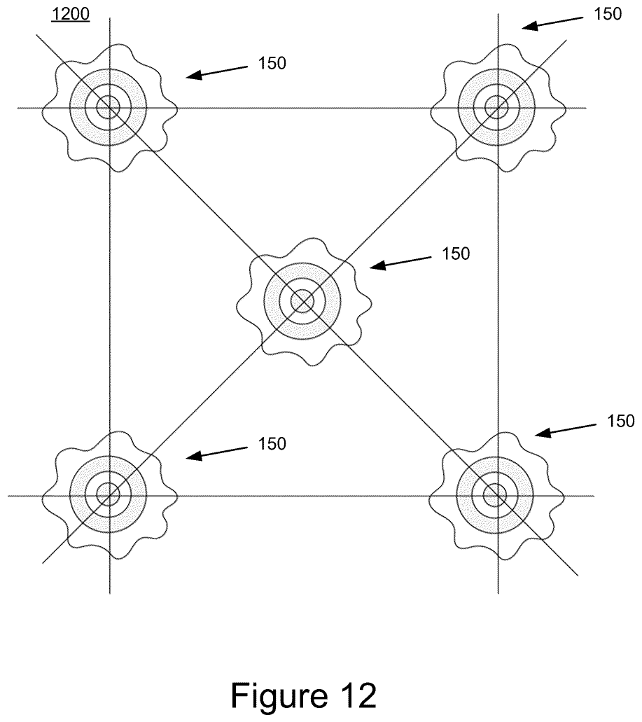

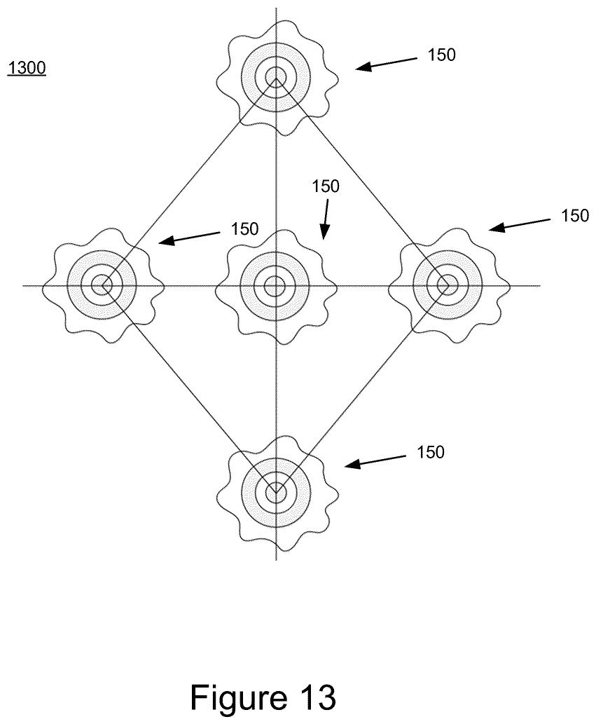

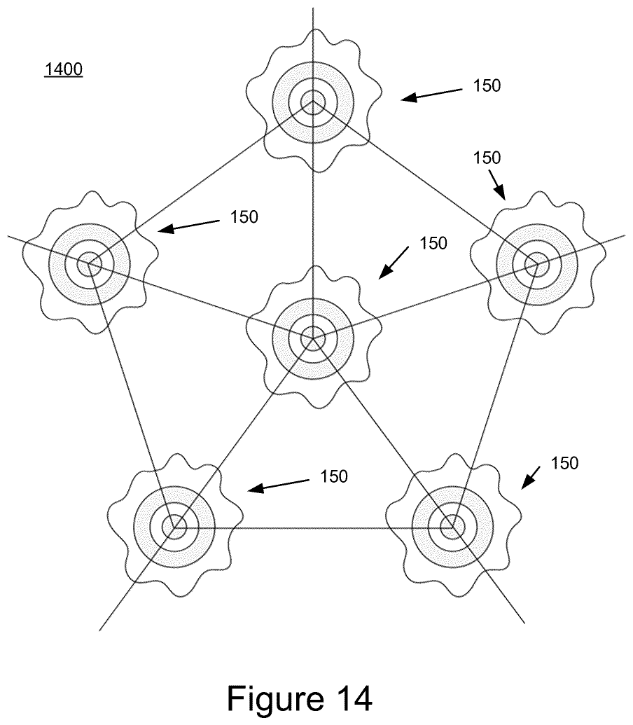

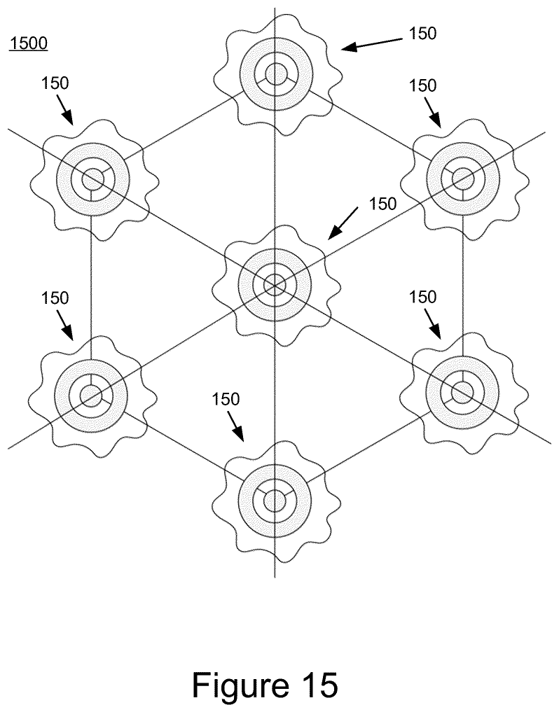

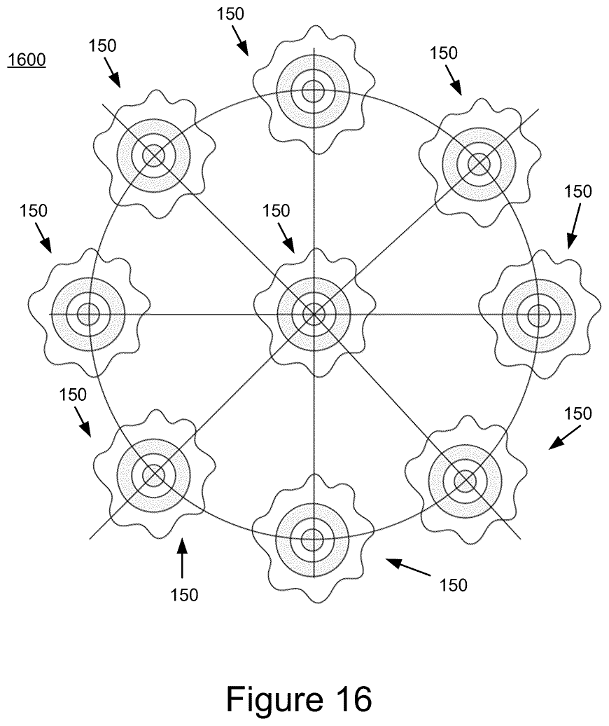

By way of further illustration, FIG. 11 illustrates an example triangular network 1100 of connector devices 150, FIG. 12 illustrates an example rectangular network 1200 of connector devices 150, FIG. 13 illustrates an example diamond-shaped network 1300 of connector devices 150, FIG. 14 illustrates an example pentagonal network 1400 of connector devices 150, FIG. 15 illustrates an example hexagonal network 1500 of connector devices 150, and FIG. 16 illustrates an example circular network 1600 of connector devices 150. Thus, arrangement and interconnection of the connector devices 150 yield numerous different network configurations.

Referring again to FIGS. 1A, 2A-2D, 3, and 4 the modular activity surface 100 may include a power unit P1. The power unit P1 may comprise a fixed block that is electrically connected to the various modules that are coupled to the base 102 of the modular activity surface. For instance, when module B1 is attached to the base 102 via the connectors C located in quadrants Q1 and Q2 of the base 102, the connectors removably security the module B1. The connectors C may also electrically connect module B1 if it is an electrical module having electrical components. Modules B may be passive or electrically capable (i.e., electrical), depending on its purpose and configuration. Non-limiting example passive or active (electrical) modules may comprise a table surface; an electrical socket for an accessory, a utensil organizer, a storage pocket, a storage compartment, a wireless docking station or charger for electronic devices (e.g., headphones, mobile phone or digital assistant, laptop, etc.), a keyboard, a pointing device, a computer accessory, a speaker, a tool organizer, a power tool support or station, and/or any other module that would be suitable based on the application, as discussed in further detail elsewhere herein.

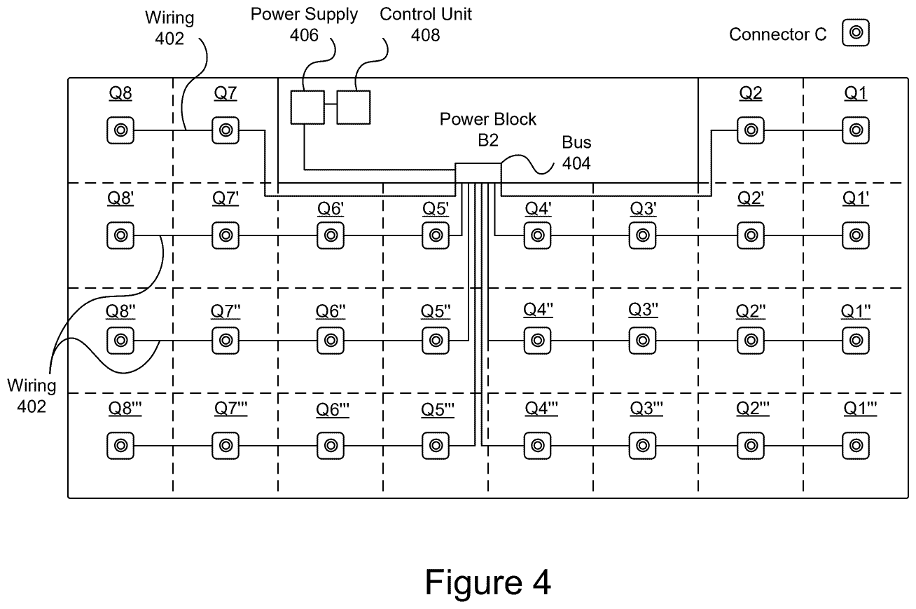

FIG. 4 illustrates an electrical schematic of the modular activity surface 100. As shown, the power unit P1 may include a power supply 406 that may be plugged into a conventional power socket or other power source and provide stable power to the power unit p1. The power supply 406 may convert input voltage from a power source, such as but not limited to a wall outlet or a battery, into the appropriate voltage, current, and frequency required by the control unit 408 and the connectors to operate correctly. The power supply may be included in various forms, including an external power brick, wall adapter, battery, or, as shown, an internal power supply within the power unit P1 device.

The control unit 408 may include non-transitory components to receive, generate, send and process signals, such as but not limited to a microprocessor, memory, network interfaces, input and output port, and a bus that interconnects the components. In some embodiments, the control unit 408 may include and/or be coupled to power switches, buttons, or other user-interactable components to power on and control the functions of the modular activity surface 100. In some embodiments, the control unit 408 may include a wireless and/or wired network interfaces (e.g., Bluetooth, Wi-Fi, NFC, ethernet, etc.) to establish and maintain a network connection (e.g., wireless) with other devices, such as modules, accessories and other objects. In some embodiments, a modular activity surface may comprise a standing desk with a moving mechanism (e.g., one or more motors and/or other components, such as those included in the desk legs) needed to raise and lower the desk to a height desired by the user. In such embodiments, the control unit 408 may include or be coupled to control components to move the desk up and down (e.g., through a wired or wireless connection). In some embodiments, the control unit 408 may include or be coupled to a screen via which a user may input commands and receive information (e.g., via the display of the screen). In some embodiments, the control unit 408 may be paired to and controllable via a remote application (e.g., such as one installable on a mobile electronic device of a user). In some embodiments, the control unit 408 may detect and control devices being plugged in and/or within a wireless area.

While not depicted, the power unit p1 may include one or more electrical ports powered by the power supply 406 to allow for each of electrically powering or charging one or more electrical accessories, such as a tablet, monitor, laptop, mobile electronic device (e.g., cell phone), etc.

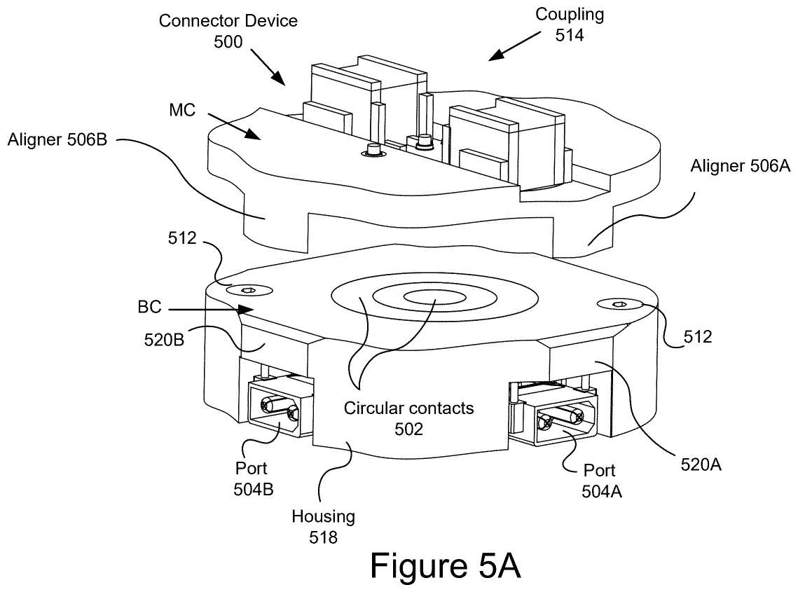

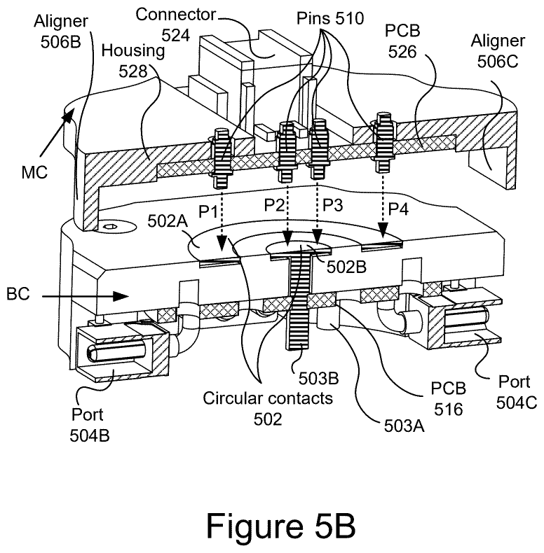

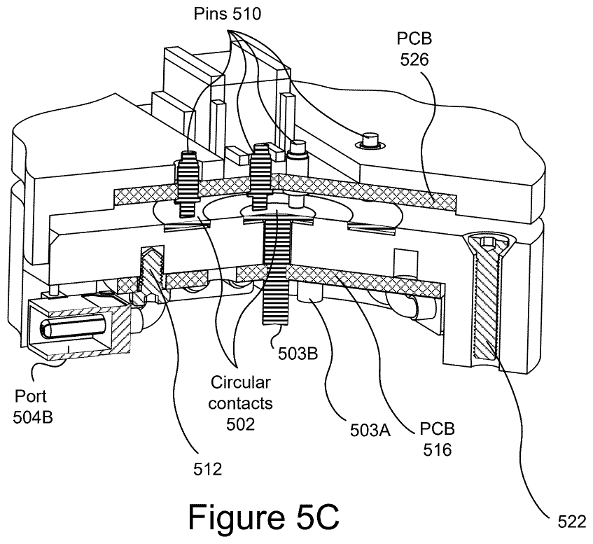

FIG. 5A illustrates a perspective view of an example connector device 500, and FIGS. 5B and 5C illustrate cross-sectional views of the example connector device 500 showing the internal structure and connection pins.

As shown, the connector device 500 comprises two parts: the base connector BC (in this example the male part) and the module connector MC (in this example the female part). The base connector BC includes a plurality of ports allowing for the connector device 500 to be electrically coupled to a one or more other connector devices 500 and/or a power supply via a bus (e.g., wiring). In the depicted embodiment, port 504B is electrically connected (e.g., via wiring, soldering, etc.) to a printed circuit board (PCB) 516, and the circular contacts 502, which extend vertically downwardly to and/or through the PCB 516 (and thus forming conductive pillars) are electrically connected to the PCB 516. The circular contacts 502 and pins 510 are made of a conductive material such as a suitable metal (e.g., copper, copper alloy, aluminum, gold, gold plating, titanium, stainless steel, etc.). The cross-sectional area of the metal pillars of the circular contacts 502 depends on the current to be transmitted and may be suitably selected based on the application.

The base connector BC includes the housing 518 that contains at least a portion of the ports 504, the circular contacts 502, the PCB 516 and other depicted components. In the depicted embodiment, the housing 518 is shaped to mate and couple with the corresponding module connector MC. In the depicted embodiment, such shaping includes corresponding aligners (e.g., flattened regions 520A and 520B) configured to interact with aligners of the module connector MC. For example, flattened region 520B is configured to interact with a corresponding flat inner surface of aligner 506B (in conjunction with other alignment components) to align the base connector BC with the module connector MC during coupling, although in other embodiments, other suitable alignment structures may be used to achieve alignment and are contemplated.

Further, in this depicted embodiment, the PCB 516 is attached to the housing 518 via one or more fasteners, such as fastener 512 (e.g., screw), and base connect BC may be secured to a base 102 via one or more fasteners 522 (e.g., screw). It should be understood that while screws are depicted, any suitable fastening device may be used and is contemplated.

In the module connector MC, connector 524, which provides electrical power through to a module when the coupling 514 is attached to a corresponding slot of a module, is electrically coupled to the PCB 526. Connector pins 510 are all electrically connected (e.g., individually in this example) to the PCB 526. Electrical connections can be achieved through any suitable manner, such as wiring and/or soldering. PCB 526 may be attached to the housing 528 (e.g., via any suitable fastener such as adhesive, screws, etc.).

In the depicted embodiment, PCB 516 facilitates stable electrical connections, connects to and/or secures the ports 504, and conducts electricity to the circular contacts 502 (e.g., concentric and/or metallic rings) through their pillars (e.g., 503A and 503B), and the PCB 526 manages the connection between the base connector BC and the module connector MC, connects to and secures the pins 510, and conducts electricity from the BC-side to the connector 524. In some embodiments, each of the contacts 502 may have one or more pillars coupled to the PCB 516 to provide electricity to the contacts 502, depending on the amount of electrical current. When the base connector BC and the module connector MC are coupled together, the pins 501 electrically couple with their corresponding circular contacts 502 as reflected by P1, P2, P3, and P4.

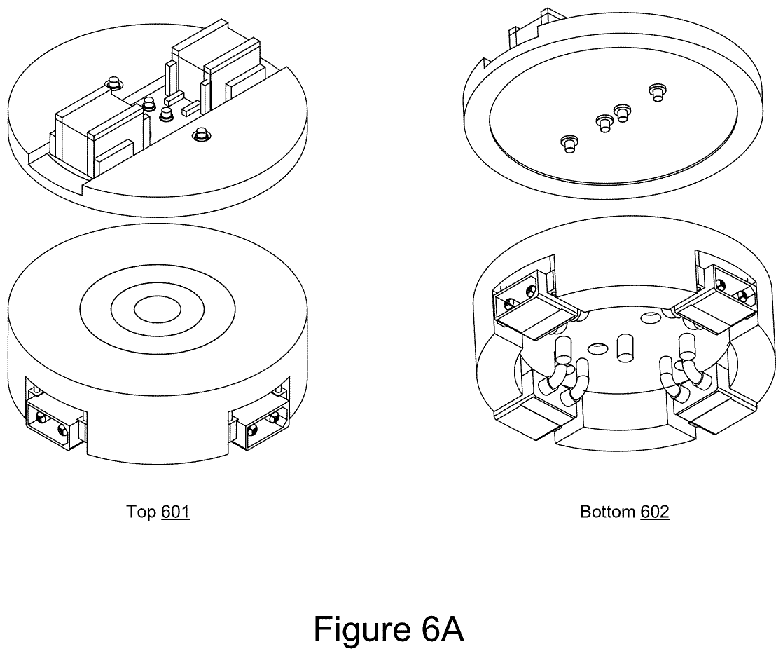

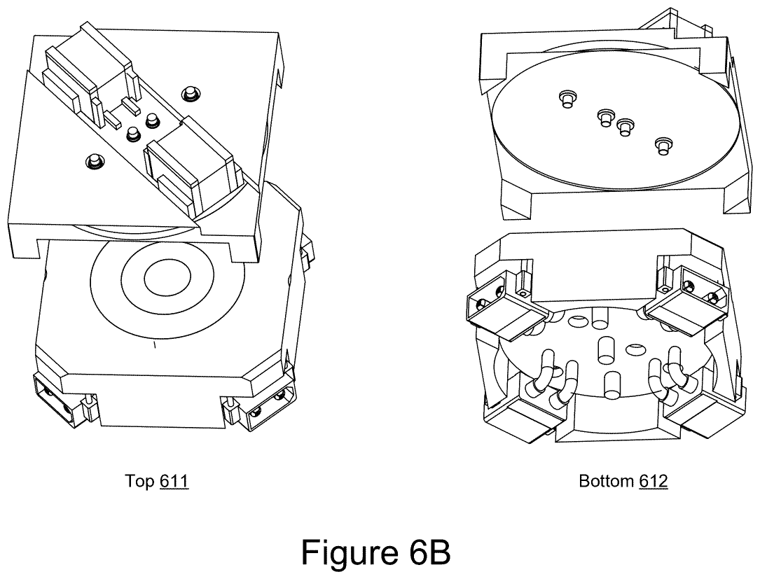

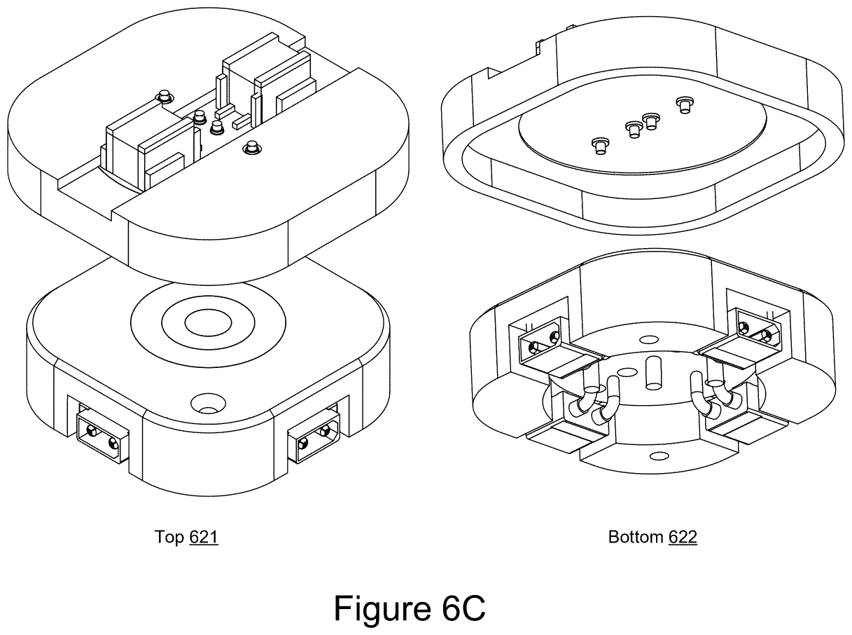

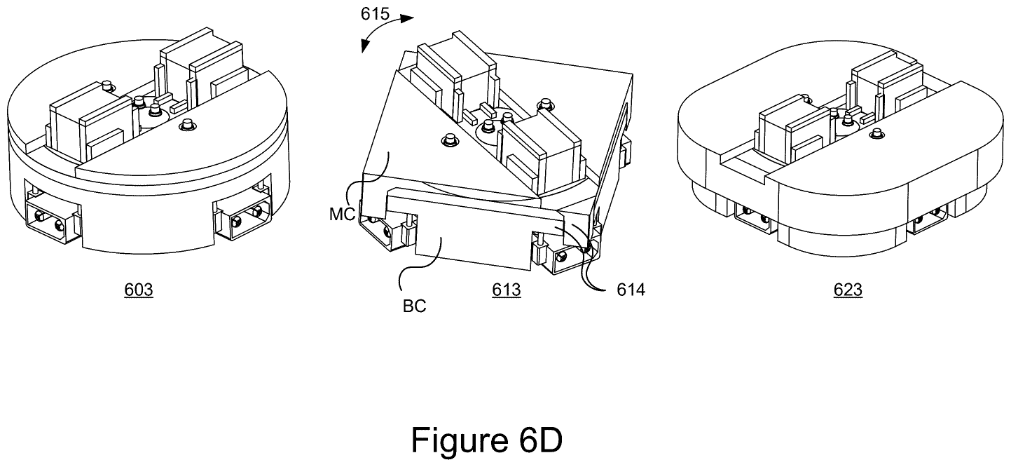

This setup advantageously allows power to be drawn from the connector 524 to supply a downstream electrical device with electrical power when the base connector BC and the module connector MC are electrically coupled. Further, the circular connector rings are advantageous as they allow the module connector MC to rotate around a central vertical axis relative to the base connector BC, thus allowing the connector device 150 to stay securely electrically connected even while in movement. Specifically, the tips of the pins 510 stay in contact with circular contacts 502 while the BC or the MC are rotated relative to another. The aligners that align the BC and MC when being coupled together may further be configured to allow for rotational movement when the BC and MC are coupled together. For example, in the coupled state 613 of FIG. 6D, the aligners 614 of the BC may be configured to allow to allow the MC and BC to rotate relative to one another as reflected by the arrow 615 (same may be applicable to any of the connector devices 150 discussed herein, and such connector devices 150 may be adapted for such a use case). More particularly, in an example embodiment, a housing 528 of a module connector MC and a housing 518 of an example base connector BC may each have a compatible, preconfigured (e.g., via a rounded, triangular, rectangular, square, etc. shape and/or via corresponding aligners shaped/formed to allow for such rotational movement) outer shape such that when the module connector MC and the base connector BC are mated, the module connector MC can rotate relative to the base connector BC while the plurality of points/pins 510 of the module connector MC maintain contact with the circular contacts of the base connector BC. In some embodiments, the rotational movement may be incremental. For example, the increments may be 1, 6, 30, 60, 90, 120, etc., degrees, which allows the connector device 150 to be held and electrically connected the base connector BC and module connector MC together in each incremental position when rotated to that position. Other variations are also possible and contemplated.

The number and dimensions of the pins 510 and/or circular contacts 502 may vary depending on the application and specifications, such as power, current intensity, and/or data transmission needs, and thus provide for a variety of different variations. For applications demanding high current transmission and cost-efficiency, larger-sized pins 510 may be substituted with multiple smaller-sized pins 510, ensuring that the total current carrying capacity matches that of a corresponding, comparatively larger pin. The pins 510 may comprise pogo pins, although other suitable connector types are also possible and contemplated.

In some embodiments, the base connector BC is generally attached to the base 102, which may comprise a table base, a floor surface, or any other surface discussed herein, in conjunction with other base connectors BC to form a network of base connectors BC configured to receive, retain, and power corresponding module connectors MC when connected. The base connectors BC are supplied power via a power supply and a bus that connects the power supply to the base connectors.

A module connector is attached to a module, such as a structural component and/or or device. Electrical modules, such as structural components and/or devices that require power receive power via the module connector when coupled to a base connector via the mating of the pins 510 and the circular contacts 502. In the depicted embodiment, when a base connector BC is mated with a module connector MC, the pins 510 are configured to deflect upward (e.g., via springs or other suitable elastic mechanisms) so as to provide downward pressure on the circular contacts 502 and ensure a secure electrical connection. When mated, the respective pins 510 and circular contacts 502 are designed to be compatible with each other to help ensure a secure and stable connection between the two parts.

In example cases that use a high current, connector 4 and ports 504 may comprise thicker or higher capacity material and/or wiring to help ensure safe operation and appropriate current ratings. Similarly, depending on the application, the circuit traces on the PCBs 516 and 526 must accordingly sufficiently sized or may comprise appropriate material (e.g., tin plating) to help enhance load-bearing capacity.

FIGS. 6A, 6B, 6C, 6D, 7, 8, and 9 depict further variations of a connector/connector device 150 that includes similar functionality to that described with reference to FIGS. 5A, 5B, and 5C. Specifically, FIG. 6A illustrates top 601 and bottom 602 perspective views of an example connector having connection pins in a circular configuration; FIG. 6B illustrates top 611 and bottom 612 perspective views of an example connector having connection pins in a circular configuration and housing having a diamond-shaped configuration; FIG. 6C illustrates top 621 and bottom 622 perspective views of an example connector having connection pins in a circular configuration and housing having a square-shaped configuration with rounded corners;

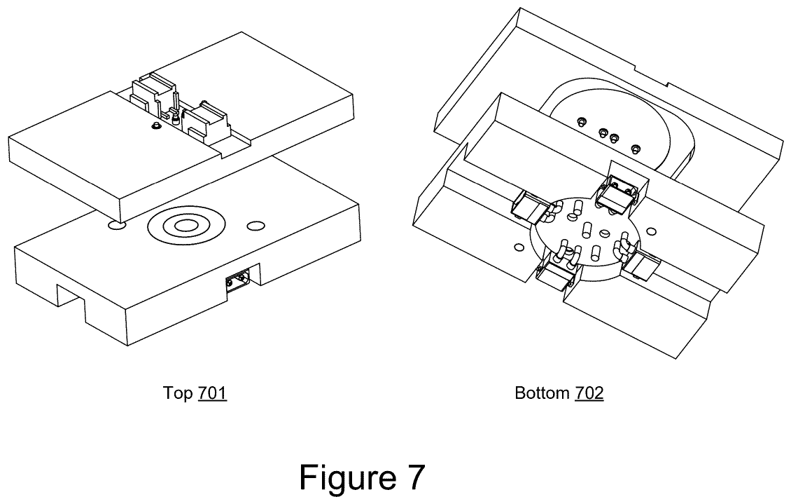

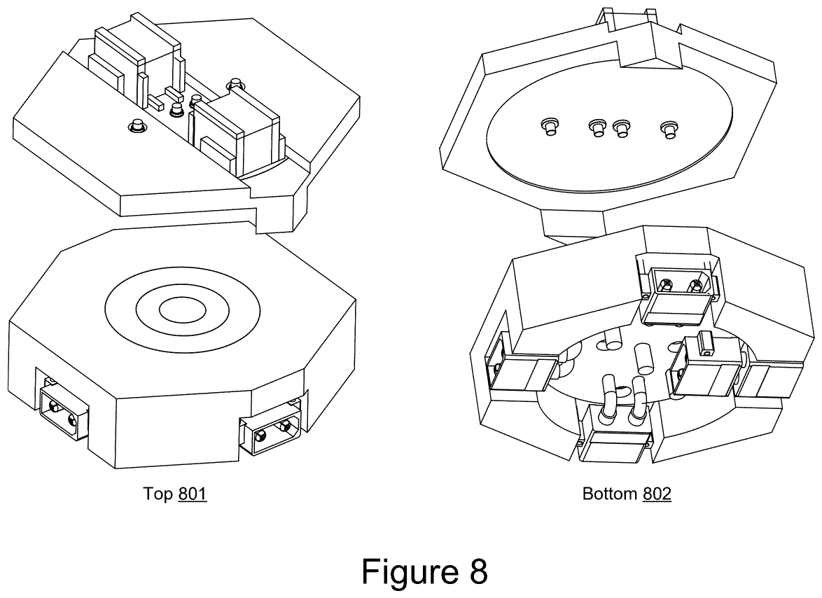

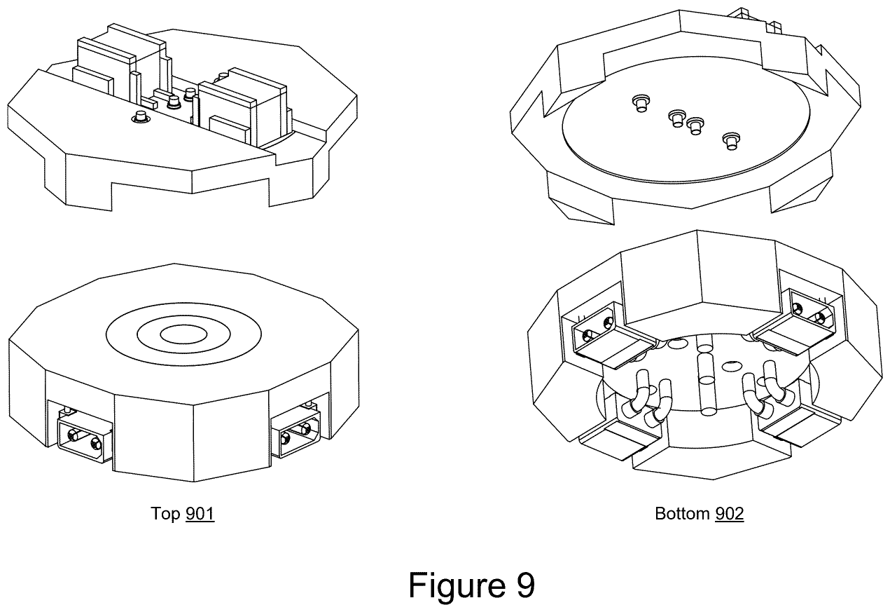

FIG. 6D illustrates perspective views of the example devices of FIGS. 6A, 6B, and 6C in a coupled states 603, 613, and 623, respectively; FIG. 7 illustrates top 701 and bottom 702 perspective views of an example connector having connection pins in a circular configuration and housing having a rectangular-shaped configuration; FIG. 8 illustrates top 801 and bottom 802 perspective views of an example connector having connection pins in a circular configuration and housing having a hexagonal-shaped configuration; and FIG. 9 illustrates top 901 and bottom 902 perspective views of an example connector having connection pins in a circular configuration and housing having an octagonal-shaped configuration.

In some embodiments, the various networks of connector devices may be configured by arranging and connecting the platforms to establish a distributed power or data network within a machinery or electronic device system. For example, each connector device may be positioned and linked to specific electronic devices or machinery within the system, each connector device may be positioned and attached to connector ports on electronic devices or machinery, facilitating the easy and convenient connection, and/or each connector device may be arranged and connected according to a specific structure or pattern to meet specific requirements of the system or application.

The connector devices 150 described herein provide a number of benefits and advantages. For example, a connector device 150 is capable of linking and supplying power to a variety of devices in a number of different applications, such as but not limited to household consumer devices, and/or electrical appliances in office settings. It is also capable of furnishing a device capable of rapidly transmitting electricity and enabling hot swapping, while ensuring electrical safety and reliability. The interconnection of multiple connector devices allows for the formation of a network of connector devices. The configuration of the pins and circular contacts further enables the pins to connect to the circular contacts in the correct positions.

The foregoing description, for purpose of explanation, has been described with reference to various embodiments and examples. However, the illustrative discussions above are not intended to be exhaustive or to limit the invention to the precise forms disclosed. Many modifications and variations are possible in view of the above teachings. The various embodiments and examples were chosen and described in order to best explain the principles of the invention and its practical applications, to thereby enable others skilled in the art to utilize the innovative technology with various modifications as may be suited to the particular use contemplated.

What is claimed is:

1. A modular activity surface comprising:
a base including a base surface having a plurality of base connectors that are spaced apart from one another; and
a plurality of modules, each module of the plurality of modules having a top surface and a bottom surface, wherein a first module of the plurality of modules has a first module connector located on the bottom surface of the first module that is configured to connect to a first base connector from the plurality of base connectors of the base when the first module is removably attached to the base.

2. The modular activity surface of claim 1, wherein coupling the first module connector of the first module to the first base connector of the base removably fastens the first module to the base.

3. The modular activity surface of claim 1, wherein the top surface of the modules of the plurality of modules comprises one of a portion of a table surface; an electrical socket for an accessory, a utensil organizer, a storage pocket, and a storage compartment.

4. The modular activity surface of claim 1, further comprising:
a power unit electrically connected to the plurality of base connectors and configured to electrify the plurality of base connectors.

5. The modular activity surface of claim 4, wherein the first module connector includes an electrical component, and coupling the first module connector of the first module to the first base connector of the base removably fastens the first module to the base and electrically connects the electrical component to the first base connector via the first module connector.

6. The modular activity surface of claim 1, wherein:
the plurality of modules includes a second module connector spaced a certain distance apart from the first module connector;
the plurality of base connectors includes a second base connector spaced the certain distance apart from the first base connector; and
the first module is removably fastened to the base comprises by coupling the first module connector of the first module to the first base connector of the base and coupling the second module connector for the first module to the second base connector of the base.

7. The modular activity surface of claim 1, wherein the first module is removably fastenable to the base via one of two base connectors, three base connectors, and four base connectors.

8. The modular activity surface of claim 1, wherein:
the plurality of modules includes a second module having a second module connector located on the bottom surface of the second module that is configured to connect to a second base connector from the plurality of base connectors of the base when the second module is removably attached to the base.

9. The modular activity surface of claim 8, wherein the first module and the second module collectively form at least a portion of a bearing surface of the modular activity surface when removably attached to the base.

10. A device connector, comprising:
a module connector having a plurality of pins electrically connected to a first circuit and a connector; and
a base connector having a plurality of circular contacts configured to mate with the plurality of pins when the module connector and base connector are mated, the base connector having a port for receiving electrical power, the plurality of circular contacts and the port being electrically coupled to a second circuit, wherein the module connector is configured to supply electrical power when the module connector is electrically coupled to the base connector.

11. The device connector of claim 10, wherein the pins of the plurality of pins comprise pogo pins.

12. The device connector of claim 10, wherein the circular contacts of the plurality of circular contacts are concentric.

13. The device connector of claim 10, further comprising:
a housing of the module connector and a housing of the base connector each have a preconfigured shape such that when the module connector and the base connector are mated, the module connector can rotate relative to the base connector while the plurality of pins of the module connector maintain contact with the circular contacts of the base connector.

14. The device connector of claim 10, further comprising:
a housing of the module connector and a housing of the base connector each has a rectangular or square outer shape such that when the module connector and the base connector are mated, the module connector can rotate around a vertical axis relative to the base connector in 90 degree increments while the plurality of pins of the module connector maintain contact with the circular contacts of the base connector.

15. The device connector of claim 10, further comprising:
a housing of the module connector and a housing of the base connector each has a triangular outer shape such that when the module connector and the base connector are mated, the module connector can rotate around a vertical axis relative to the base connector in 120 degree increments while the plurality of pins of the module connector maintain contact with the circular contacts of the base connector.

16. A network of device connectors, comprising:
a plurality of connector devices each having a plurality of ports, each connector device having a plurality of ports allowing up and downstream electrical connections to a power supply, a first connector device of the plurality of the connector devices being electrically coupled to a power supply via first port and being electrically coupled to a downstream port of a second connector device, each of the connector devices including a module connector that is electrically detachably coupled to a base connector.

17. The network of device connectors of claim 16, wherein:
the network includes at least one or more of a circular network of the connector devices from the plurality of connector devices, a triangular network of the connector devices from the plurality of connector devices, a square network of connector devices from the plurality of connector devices, a rectangular network of connector devices from the plurality of connector devices, a diamond network of the connector devices from the plurality of connector devices, a pentagonal network of the connector devices from the plurality of connector devices, a hexagonal network of the connector devices from the plurality of connector devices, and a star-shaped network of the connector devices from the plurality of connector devices.

18. The network of device connectors of claim 17, wherein the square network, diamond network, and the rectangular network include four or more device connectors; the pentagonal network includes five or more device connectors; the hexagonal network includes six or more device connectors; and the star-shaped network includes six or more device connectors.

19. The network of device connectors of claim 17, wherein one or more of the square network, the diamond network, the rectangular network, the circular network, the triangular network, the pentagonal network, the hexagonal network, and the star-shaped network include a central connector device.

20. The network of device connectors of claim 17, wherein the network provides for power transmission and data transmission between the device connectors of the plurality of device connectors.
